(19) United States
(12) Patent Application Publication
(10) Pub. No.: US 2011/0194667 A1
(43) Pub. Date: Aug. 11, 2011

(54) DOPANTS FOR HIGH BURNUP IN METALLIC NUCLEAR FUELS

(75) Inventor: Robert Dominick Mariani, Idaho Falls, ID (US)

(73) Assignee: BATTELLE ENERGY ALLIANCE, LLC, Idaho Falls, ID (US)

(21) Appl. No.: 12/702,077

(22) Filed: Feb. 8, 2010

(51) Int. Cl. G21C 3/07

(52) U.S. Cl. 376/418

(57) ABSTRACT

A binary or ternary metallic fuel composition having a metal dopant content of about 1 at. % to 25 at. %. A metal dopant is added to the binary or ternary metallic fuel composition to extend metal fuel burnup. The metal dopant will pin the lanthanides in the fuel phases. For binary U—Zr fuels, the metal dopant is generally palladium or titanium. For ternary U—Pu—Zr fuels, the metal dopant is generally palladium or a mixture of silver and titanium.

### GOVERNMENT RIGHTS

This invention was made with government support under Contract Number DE-AC07-05ID14517 awarded by the United States Department of Energy. The government has certain rights in the invention.

### TECHNICAL FIELD

This invention relates generally to adding a metal dopant to metallic nuclear fuels to extend fuel burnup.

### BACKGROUND

Nuclear power is recognized as a means to eliminate carbon dioxide emissions in the production of large quantities of energy, but radioactive waste disposal remains an issue. The secure and timely disposal of transuranic materials (primarily plutonium) has been the subject of intense debate in recent years. Spent fuel from existing nuclear power reactors is a primary source.

Large quantities of transuranics are contained in the spent fuel inventories of existing nuclear reactors. This material does not pose an immediate proliferation concern because it already exists in a dilute (transuranics constitute about 1% of the total heavy metal mass) and highly radioactive form. Destruction of the separated transuranic material does however reduce the long-term radiological and proliferation hazards.

Therefore, sufficient motivation exists for eventual destruction of the transuranics from spent fuel, i.e., the reduction of proliferation and radiotoxicity hazards. Destruction by fission is the only means available to permanently destroy the transuranics. Although fission creates radioactive fission products that have a higher short-term hazard than the original fuel material, the fission products decay much more rapidly than the transuranics, so the long-term hazard is significantly reduced. Furthermore, the energy produced by the fission reactions can be converted to electrical power (the fission of 1 MT of actinides yields enough energy to produce approximately 1 GWe-year of electricity), and the sale of this power allows revenue recovery for the disposition activity. In order for the transuranics to be eliminated from the spent fuel waste stream, the spent fuel must be treated to recover the transuranics for subsequent incorporation into fresh nuclear fuel for burning. Treated appropriately, the long-term radiological and proliferation risks of the transuranics can be controlled.

In conventional fission nuclear reactor systems, the net transuranic destruction rate is reduced by in-situ production of Pu-239 (by U-238 neutron capture). The available range of destruction/production characteristics in metal-fueled cores allows a flexible transuranic management strategy. Conventional fast reactor cores can maintain or even increase the transuranic inventory (conversion ratio of 1.0 to 1.3); this allows sustained power production from a fixed transuranic inventory. By removing fertile material and/or altering the neutron balance, the conversion ratio can be reduced. Core designs with conversion ratios between 0.5 and 1.0 have been investigated; further reductions in the conversion ratio would require transuranic contents greater than 30 weight percent, as previously investigated in the Integral Fast Reactor (IFR) metal fuels testing program. The partial burner core designs, with 0.5 to 1.0 conversion ratios, are referred to as conventional burner designs because they utilize conventional IFR metallic fuel alloys.

Because the minimal conversion ratio of conventional burners is 0.5, conventional burners can achieve transuranic consumption rates of roughly half the maximum value of (½×1 g/MW,d). To allow more rapid destruction of the transuranics, non-conventional metal fuel alloys are required; to achieve the maximum transuranic consumption rate of 1.0 g/MW,d, a non-uranium fuel form is required. Preliminary neutronic investigations of non-uranium core designs (called “pure burners” because they achieve the maximum destruction rate) have been discussed in R. N. Hill, D. C. Wade, E. K. Fujita, and H. Khalil, “Physics Studies of Higher Actinide Consumption in an LMR.” International Conference on the Physics of Reactors, Marseille, France, Apr. 23-27, 1990, pp. 1-83; R. N. Hill, “An Evaluation of Reactivity Coefficients for Transuranic Burning Fast Reactor Designs,” Transactions of the American Nuclear Society, Vol. 65, p. 450 (1992); and GE Nuclear Energy, “Plutonium Disposition Study,” GEFR-00919, May 1993.

Improvements in the management and economics of nuclear energy production are needed. Increasing the burnup capacity of the fuel, in the sense that a larger fraction of the original charge of uranium is consumed in the fission process, has become increasingly important. Obvious cost reductions would result from reduced fabrication of fuel assemblies and reduced reactor core maintenance. Since fuel fabrication processes range all the way to mining and enrichment processes, cost savings for large increases in burnup capacity can be substantial when passed to the utilities and customers. In addition, radioactive waste disposal is partly remedied because the waste volume would be reduced for increased burnup.

In metallic nuclear fuels, a major factor affecting fuel lifetime and burnup is the chemical interaction between the cladding and the fuel with fission products. It is commonly designated FCCI (fuel cladding chemical interaction). As a consequence of FCCI, the cladding can become weakened and can breach so that the fuel comes into direct contact with the primary coolant of the reactor. While the primary coolant system of reactors is designed to accommodate fuel failures, cladding failure is undesirable unless a run-to-breach test is intended.

FCCI in metallic nuclear fuels is known to involve fuel-cladding interactions as well as fission product-cladding interactions, where the cladding is typically a stainless steel. Stainless steel components such as iron and nickel are known to migrate from the cladding into the fuel matrix to dissolve in or react with the uranium and plutonium. Fission products, and actinides to a minor extent, are known to migrate from the fuel matrix and deposit within the cladding. In particular, lanthanide metal fission products, such as lanthanum, neodymium, cesium, praseodymium, and the like, migrate from the fuel and interact with the cladding. Based on the amounts of different elements that interact with and deposit within the cladding, the lanthanide interaction with the cladding is strongest and most pronounced, compared to other irradiated fuel components, under reactor operating conditions.

Metallic nuclear fuel for power production follows a cylindrical fuel element design. For EBR-II (Experimental Breeder Reactor-II) type fuels, alloys of U—Zr and U—Pu—Zr are cast into cylindrical rods (often referred to as “slugs”) on the order of 0.17 inch diameter, with various lengths depending on the actual reactor being employed. The slugs are inserted into a cylindrical stainless steel jacket that constitutes the cladding. After liquid sodium is added to fill the annular void between the slug and the cladding, the top is welded shut. The sodium serves as a thermal bridge, or bond agent, between the fuel slug and the cladding to help carry away the heat. The completed part, with a helical wire wrap around the exterior stainless jacket to assist coolant flow, is designated a fuel element.

Zirconium is added as an alloy component to help reduce FCCI, as zirconium is known to form a thin rind on the peripheral fuel surface that impedes contact between cladding and other fuel components. Zirconium is also added as an alloy component because it lowers the onset temperature for γ-U formation (otherwise reported as stabilizing the γ-U phase). The γ-U phase is desirable in comparison to other uranium phases because the crystal lattice is cubic. Under the influence of process heat of fission, the cubic γ-U must expand isotropically, i.e., the same in all directions. Prior experience with casting other fuel alloys resulted in preferred “textures” for the cast fuel alloy, so that the anisotropic phases of uranium expanded preferentially in the axial direction, rather than isotropically on average. Anisotropic expansion is very undesirable because the nuclear reactivity of the fuel alloy becomes less predictable, resulting in reduced fuel lifetime and burnup.

Lanthanide metals phase-segregate from the fuel alloy matrix, transport to the fuel slug peripheral surface, and precipitate on the fuel slug peripheral surface.

Praseodymium (Pr) has a high solubility in liquid cesium (Cs), which is a fission product like the lanthanide metals, and Cs is liquid (molten) at reactor temperatures. The solubility of Pr in liquid Cs indicates that other lanthanides will exhibit substantial solubility in liquid cesium. Under the influence of the thermal gradient existing across the fuel slug radius, the lanthanides will transport to the colder regions of the fuel since there is never enough cesium to dissolve all of the lanthanides (the fission product ratios do not support the dissolution of all lanthanides in cesium). The transport process can be thought of as lanthanide metals undergoing multiple dissolution and precipitation events along the decreasing temperature gradient toward the colder regions where the lanthanides are least soluble. On the other hand, cerium (Ce) has a very low solubility in liquid sodium, as will the other lanthanides therefore. As a consequence, the lanthanides migrating in solution, through fuel pores and along fissures, will “crash out of solution” upon contacting the large excess of liquid sodium in the annular region between the fuel slug and the cladding.

The prevention of the FCCI between cladding and the lanthanides has been addressed. Y. S. Kim, G. L. Hofman and A. M. Yacout discuss in particular the addition of indium and thallium in reactor fuels such as U—Pu—Zr fuels during the casting operation so that thermodynamically stable compounds can form with the lanthanide fission products and halt their migration. (See Migration of Minor Actinides and Lanthanides in Fast Reactor, Journal of Nuclear Materials 392 (2009) 164-170.)

Accordingly, there is a need for improved burnup capacity for metallic nuclear fuels. There is a further need to minimize the reaction of the lanthanides with the cladding. There is still a further need for dopants for metallic fuels that interact strongly with lanthanides so as to halt their migration within the fuel matrix, without compromising the performance of the alloy fuel matrix.

### BRIEF SUMMARY OF THE INVENTION

The present invention relates to a binary or ternary metallic fuel composition comprising a metal dopant that alloys with lanthanide fission products as they form and prevents migration of the lanthanides as solid, solution and/or intermetallic phases from a fuel matrix to cladding wherein the metal dopant is selected from the group consisting of titanium, palladium, silver and/or mixtures thereof.

In addition, the metal dopant stabilizes the gamma phase of uranium (γ-U) in uranium alloy fuel compositions. The metal dopant forms a solid solution with the fuel composition for at least some portion of the binary composition of uranium and the metal dopant, to enable uniform dispersion of the metal dopant throughout the matrix, and support ready reaction of the metal dopant with lanthanide fission products as they form.

The present invention also provides a process to extend fuel burnup comprising adding a metal dopant selected from the group consisting of titanium, palladium, silver and/or mixtures thereof to a binary or ternary metallic fuel to achieve up to at least about a 14% burnup.

High dopant levels may be used that allow for very high burnups of metallic fuels in nuclear reactors, up to optimized dopant and burnup levels that achieve the desired nuclear reactivity as determined by the volume fraction of uranium—in either fresh or end-of-life fuel form—uranium enrichment, and reactor core design. Volume fractions of uranium, uranium enrichments, and core designs differ widely historically but they are strongly interdependent. Other features, aspects, and advantages of the present invention will become better understood with reference to the following description.

### DETAILED DESCRIPTION OF THE INVENTION

The thermodynamics and mass transport of major fission products, lanthanides in particular, have been analyzed for EBR-II type spent fuel. The analysis gives a basis for the transport of the lanthanides, their interaction with and lodging in the cladding. The analysis distinguishes between the cladding component behavior with the fuel matrix and the lanthanide behavior with the cladding. Iron and nickel leach from the cladding to transport and interact with the fuel matrix. The lanthanides precipitate on the fuel periphery and interact with the cladding via transport or physical contact upon fuel swelling. On the basis of their observed behavior and the analysis, it has been found that certain metal dopants will pin the lanthanides in the fuel phase.

Lanthanides phase segregate from the metallic nuclear fuels and precipitate on the exterior of the fuel pin. Lanthanides transport as solutes in Cs, a major fission product that is liquid at reactor operating temperatures. Lanthanides are all presumed to be soluble, based on the established chemical similarities of the lanthanides and the known high solubility of praseodymium in liquid cesium (Cₛ). The lanthanides are all presumed to be sparingly soluble in liquid sodium (Na), providing the thermal bond in an annulus between the fuel slug and the stainless steel cladding, because cerium (Ce) has an extremely small solubility in liquid Na. The lanthanides are known to attack the fuel cladding, and this interaction is a major limitation of metallic fuel life.

In the analysis it is recognized that thermodynamics play a major role because of the high temperatures and long times; consequently, the most stable phase will form if provided a suitable transport mechanism to bring reactants together. Transport can occur as gases (e.g., Xe and possibly metal iodides), liquids (Cs, Rb, K, Li, Na, Te, Se, Sn, and Cd are present below their melting points), liquid solutions (e.g., Pr in liquid Cs), and as solids. The path of least resistance will of course dominate for the specific transport mechanism, e.g., liquids in their liquid range.

Intermediate phases, in trace or undetected amounts, can assist transport to form the most stable phase. For example, the cerium-rich side of the Ce—Fe phase diagram exhibits a low eutectic temperature relative to fuel temperatures so that some liquid may be expressed on contact of cerium with iron. Once the liquid separates from the solid, the liquid phase can then transport to the fuel matrix more rapidly than solid transport alone, either as a dispersed solid precipitate or as a solute. The U—Fe compounds are more stable than the Ce—Fe compounds, as evidenced by their higher melting points. The iron is therefore stabilized in the fuel matrix rather than in the lanthanide precipitate on the fuel surface, even though the iron was removed from the cladding by interacting with the lanthanide in the first place.

It is not necessary that a liquid or solution be exhibited in order for rapid transport to occur. At temperatures near liquid phase formation of a metal alloy or compound, the cohesive energy of the metal phase is near collapse. At such temperatures, the bond energy of individual atoms within the metal phase is weak relative to available amount of thermal energy. Consequently, atomic transport on pores, grain boundaries, and surfaces of fissures will be rapid.

Ordinary transport of solid material, as in traditional solid diffusion, will be slow relative to the above processes. This is evident from the fact that the reaction zone set up in the cladding wall, between lanthanides and stainless steel components, does not progress rapidly to cladding breach. Once the reaction zone forms, lanthanides must diffuse through it to contact and react with iron or nickel, and iron must diffuse out of the cladding and through the reaction zone to contact more lanthanide. In fact, for binary nickel-rich lanthanide systems, some liquid will be expressed at temperatures as low as 477° C. However, the lanthanide-rich side of the reaction zone in cladding (and of the binary system) has a higher solidus temperature (for iron or nickel), and the incipient solid phases will impede further transport of nickel out of the cladding. The presence of the reaction zone therefore slows the rate of FCCI relative to the initial rate of interaction, and forces traditional solid diffusion transport mechanisms for the most part.

Temperature gradients can drive precipitation phenomena for liquids below their melting points and for solutes from solutions. Lanthanide transport is driven by dissolution and precipitation, and clear evidence is found in the pores, arising as a consequence of fission and thermal expansion, within spent fuel. Lanthanides collect on the cold side of pores, in the direction toward the outer radius of the fuel slug, which requires their transport to be driven by temperature gradients. This observation does not require the lanthanides to precipitate from solution, but the high solubility of praseodymium in cesium, the existence of lanthanides in excess of the solubility limits for the amount of cesium present, and the high melting points of the lanthanides demonstrate the path of least resistance to be solution-based transport driven by a temperature gradient. The process can be thought of and modeled (e.g., finite difference method) as higher temperature regions dissolving higher lanthanide contents and colder temperature regions precipitating lanthanides as the solubility is less, while allowing for the liquid metal to circulate, on the pore surface, for example. Under a condition the liquid metal is saturated at all temperatures in the circuit of liquid, the net result is transport from the hot regions to the cold.

At some point as the fuel is irradiated it becomes swollen and porous enough for the lanthanides to transport to the fuel slug peripheral surface. In this region there is a large amount of liquid sodium serving as the thermal bond agent between the fuel slug and the cladding. The lanthanides, however, are much less soluble in liquid sodium as compared to liquid cesium. Cerium, in fact, is known to be sparingly soluble in liquid sodium, and the other lanthanides are inferred to be so for their extremely similar chemical properties (the lanthanides occur in nature together and are known to be the most difficult group to separate into the pure elements). The lanthanides crash out of solution on contact with the large reservoir of sodium, agglomerating as a porous solid precipitate along with trace amounts of palladium and plutonium, despite the even lower temperature of the cladding in comparison to the fuel slug surface. Despite the low solubility in liquid sodium, some lanthanide transport through the sodium will occur and some FCCI is in fact observed even before the swollen irradiated fuel slug makes physical contact with the cladding. After physical contact, FCCI is more pronounced.

The present invention analyzes the distinguishing behaviors for the lanthanides and the cladding components. In particular, where the lanthanides are known to interact with the cladding and lodge in the cladding, the cladding components, by contrast, do not lodge in the lanthanide precipitate on the fuel slug surface. Instead, any iron or nickel that comes out of the cladding transports across the lanthanide deposit into the fuel slug matrix to lodge in it, demonstrating the existence of a transport mechanism. The reasons that the iron and nickel transport are the transport mechanism and the more stable state that the fuel matrix presents to the cladding components. Since cladding components are stabilized in the fuel matrix, it has now been found that metal dopants of the present invention stabilize the lanthanide fission products also in the fuel matrix, and inhibit or preclude their transport and subsequent FCCI. In effect, a more stable thermodynamic state for the lanthanides has been found as compared to the thermodynamic state that the cladding offers to the lanthanides.

The metal dopants of the present invention will pin the lanthanides in the fuel phases and prevent their migration as solid, solution or intermetallic phases. In the present invention, the metals that pin the lanthanides form solid solutions with uranium or plutonium, so the metal-pinning agents are dispersed uniformly to react promptly with the lanthanide fission products as they form. In the present invention, the metal-pinning agents, or metal dopants, for U—Zr alloys, stabilize the gamma phase of uranium (γ-U) so that their combined interaction with zirconium in the fuel matrix, which also stabilizes γ-U, will act in concert to further stabilize γ-U. Since γ-U is the only uranium allotrope that undergoes isotropic thermal expansion, its presence in the fuel assures more uniform and predictable nuclear reactivity.

Metal dopants useful in the present invention give higher solidus temperatures for lanthanides in the fuel matrix relative to the temperatures of metallic fuel under normal irradiation. The metal dopants give solid solution behavior in the metallic fuel alloys such that the lanthanides can react promptly on forming. Suitable metal dopants include titanium, palladium, silver and mixtures thereof.

In one embodiment, palladium (Pd) dopants have been found to pin lanthanides in place with high melting intermetallic compounds in both binary and/or ternary metallic fuels. Palladium-poor lanthanide systems correspond to existing systems in the absence of the invention, where lanthanide fission products are in great excess over palladium and some palladium is found with the lanthanides on the fuel slug surface. Pd is soluble in Na, which accounts for its transport once the fuel slug is highly porous and the Na and Cs liquids mix. On the other hand, palladium-rich lanthanide systems are high melting, so palladium dopants will stabilize the lanthanides in the fuel matrix. The solidus for Nd—Pd with excess Pd is 865° C., but the solidus with excess Nd is only 620° C. In Pd-rich systems, such as in Pd doped fuels, dispersed Pd and liquid Cs will bring Pd and lanthanides together to precipitate in place. Pd dopants will pin lanthanides in both Pu phases and U phases, in U—Zr and U—Pu—Zr fuels.

In another embodiment, titanium (Ti) dopants have been found to pin lanthanides in U fuel phases. Ti gives moderately high solidus temperatures in Ti-lanthanide systems (790° C. in Ce—Ti, 960° C. in Nd—Ti). Ti has complete solid solubility in gamma-U and stabilizes it at 94 at. % U. However, solid Ti has very low solubility in solid Pu. Therefore, lanthanide fission products forming in Pu phases may not encounter Ti as they transport to the fuel slug surface, and Ti in U—Pu—Zr fuels will be somewhat less effective than Ti in U—Zr fuels. Ti dopants will nevertheless extend burnup for U—Zr fuels and for U—Pu—Zr fuels and the benefit for U—Pu—Zr fuels will be somewhat less than for U—Zr fuels.

In a further embodiment, silver (Ag) dopants have been found to pin lanthanides in Pu phases. Ag gives moderately high solidus temperatures in excess Ag-lanthanide systems (e.g., 791° C. for Ag—Ce). Ag has high solid solubility in Pu. Solid Ag has no solid solubility with U. Therefore, a mixture of Ag to pin lanthanides in Pu phases and Ti to pin lanthanides in U phases may be used in U—Pu—Zr fuels.

The metal dopant is added during fabrication of the fuel using conventional methods. For example, the fuel alloy is constituted by weighing the amounts needed of pure elements or of assayed alloys to obtain the desired composition. After assembling the needed weighed amounts, the combined metals are melted in a suitable crucible, such as in an induction furnace, for example. The metal may then be poured into molds to produce rods, commonly referred to as slugs. In another method, the metal may be injected into molds using a pressurized furnace to push the molten metal into the molds. Whatever casting method is used, the outcome is a fuel slug with the desired composition, typically within a stated tolerance.

The metal dopant may be used in at least about a 1:1 metal dopant to lanthanide atomic ratio to pin the lanthanides in the fuel matrix. For binary U—Zr fuels, metal dopant Pd, Ti, and/or mixtures thereof is used in an amount in the range of from about 1 at. % to about 25 at. %, generally in an amount in the range of from about 3 at. % to about 15 at. %. For example, Pd (3 at. %) will precipitate high melting phases involving the lanthanides up to approximately 8% burnup.

For ternary U—Pu—Zr fuels, metal dopant Pd, Ti, a Ag—Ti mixture, a Pd—Ti mixture, and/or a Pd—Ag mixture is used in an amount in the range of from about 1 at. % to about 25 at. %, generally from about 3 at. % to about 15 at. %. For example, Pd (3 at. %) or an Ag—Ti mix (1.5 at. % each) will precipitate high melting phases involving the lanthanides up to approximately 8% burnup.

The metal dopants of the present invention may also be used in a less than about 1:1 metal dopant to lanthanide atomic ratio to pin the lanthanides in the fuel matrix. When dopants are used in a less than about 1:1 atomic ratio, some lanthanide migration with subsequent FCCI will occur. For example, if a burnup of 20% is desired, then metal dopants may be added to account for the lanthanides that would be produced at 12% burnup. The excess lanthanide fission products will not be pinned in the fuel matrix, and the excess lanthanides will be equivalent to approximately 8% burnup without metal dopants, for which the cladding satisfactorily guards against FCCI to the extent of cladding breach, in the absence of excessive fuel swelling.

Using metal dopants that form high melting phases with lanthanides to pin the lanthanides in the fuel matrix can mitigate FCCI and extend burnup limit of metallic fuels. Generally, burnup is extended up to at least about 14% while using a metal dopant level that accounts for lanthanide fission product levels corresponding to 8% burnup without the metal dopant. Metallic fuel burnup of at least about 20%, preferably at least about 30%, and more preferably at least about 50% may be achieved using the metal dopants of the present invention.

The following non-limiting examples illustrate certain aspects of the present invention.

### Example 1

### 1:1 Metal Dopant to Lanthanide Atomic Ratio

In order to pin lanthanides in a fuel matrix of a binary fuel composition, palladium is used as a metal dopant. At 8% burnup, the lanthanides content is about 3 at. %. Dopant levels of 3 at. % are used to bind the lanthanides.

Binary: 85U—15Zr (wt % basis for unmodified binary fuel)
atom %: 68.7U—31.3Zr
83.3U—1.7Pd—15Zr (wt % basis with Pd dopant)
atom %: 66.2U—3Pd—30.8Zr

### Example 2

### Less than a 1:1 Metal Dopant to Lanthanide Atomic Ratio

In order to pin lanthanides in a fuel matrix of a binary fuel composition, titanium is used as a metal dopant. At 8% burnup, the lanthanide content is approximately 3 at. %. Dopant levels of 3 at. % are used to bind the lanthanides and increase burnup to about 16% for the same extent of FCCI as 8% burnup with no metal dopant.

Binary: 85U—15Zr (wt % basis for unmodified binary fuel)
atom %: 68.7U—31.3Zr
84.2U—0.77Ti—15Zr (wt % basis with Ti dopant)
atom %: 66.4U—3Ti—30.6Zr

### Example 3

### Less than a 1:1 Metal Dopant to Lanthanide Atomic Ratio

In order to pin lanthanides in a fuel matrix of an alternate binary fuel composition with a lesser zirconium content, titanium is used as a metal dopant. At 8% burnup, the lanthanide content is approximately 3 at. %. Dopant levels of 3 at. % are used to bind the lanthanides and increase burnup to about 16% for the same extent of FCCI as 8% burnup with no metal dopant. Comparison of Examples 2 and 3 shows that a lesser zirconium content reduces the gram amount of metal dopant required to maintain the metal dopant level at 3 at. %.

Binary: 90U—10Zr (wt % basis for unmodified binary fuel)
atom %: 77.7U—22.3Zr
89.28U—0.72Ti—10Zr (wt % basis with Ti dopant)
atom %: 75.2U—3Ti—21.8Zr

### Example 4

### Greater than a 1:1 Metal Dopant to Lanthanide Atomic Ratio

In order to pin lanthanides in a fuel matrix of a binary fuel composition, titanium is used as a metal dopant to bind all of the lanthanide fission products. At a high burnup of 30%, the lanthanide content is approximately 11.25 at. %. Dopant levels of 11.25 at. % Ti bind the lanthanides. Excess Ti dopant levels (compared to a 1:1 atomic ratio) in the range of 12-15 at. %, offer some process margin to eliminate altogether the lanthanide-based FCCI at this high burnup. Uranium enrichment, core design, or control rod placement may be modified, in comparison to the EBR-II design to achieve the reactivity needed for sustaining power throughout this burnup range.

Binary: 90U—10Zr (wt % basis of unmodified binary fuel)
atom %: 77.7U—22.3Zr
86.88U—3.12Ti—10Zr (wt % basis with Ti dopant)
atom %: 67.8U—12Ti—20.2Zr

### Example 5

### Less than a 1:1 Metal Dopant to Lanthanide Atomic Ratio

In order to pin lanthanides in a fuel matrix of a ternary fuel composition, palladium is used as a metal dopant. At 8% burnup, the lanthanides content is about 3 at. %. Dopant levels of 3 at. % are used to bind the lanthanides and increase burnup to about 16% for the same extent of FCCI as 8% burnup with no metal dopant.

Ternary: 70U—20Pu—10Zr (wt % basis for undoped ternary fuel)
atom %: 60.6U—17.1Pu—22.4Zr
68.4U—20Pu—1.6Pd—10Zr (wt % basis with Pd dopant)
atom %: 58.2U—16.8Pu—3Pd—22.0Zr

### Example 6

### 1:1 Metal Dopant to Lanthanide Atomic Ratio

In order to pin lanthanides in a fuel matrix of a ternary fuel composition, a mixture of metal dopants is used. Equal amounts of titanium and silver are used as metal dopants. A total dopant level of 7.5 at. % is used to bind all the lanthanides that would be produced at a burnup of 20%. In terms of each dopant level, this example equates approximately to 3.76 at. % Ti and 3.74 at. % Ag.

Ternary: 70U—20Pu—10Zr (wt % basis of undoped ternary fuel)
atom %: 60.6U—17.1Pu—22.4Zr
66.99U—20Pu—0.93Ti—2.08Ag—10Zr (wt % basis with Ti and Ag
dopants)
atom %: 55U—16.2Pu—3.76Ti—3.74Ag—21.2Zr

The embodiments of the invention described herein are exemplary and numerous modifications, variations and rearrangements can be readily envisioned to achieve the claims of the invention, all of which are intended to be embraced within the spirit and scope of the invention.

1. A binary or ternary metallic fuel composition, comprising a metallic fuel and a metal dopant that alloys with lanthanide fission products and prevents their migration as a solid, solution, and/or intermetallic compound from a fuel matrix to cladding, wherein the metal dopant is selected from the group consisting of titanium, palladium, silver, and mixtures thereof.

2. The binary or ternary metallic fuel composition of claim 1, wherein the metallic fuel is at least one of a uranium, zirconium, and plutonium alloy.

3. The binary or ternary metallic fuel composition of claim 2, wherein the metallic fuel is a binary U—Zr alloy.

4. The binary or ternary metallic fuel composition of claim 3, wherein the metal dopant is titanium.

5. The binary or ternary metallic fuel composition of claim 3, wherein the metal dopant is palladium.

6. The binary or ternary metallic fuel composition of claim 3, wherein the metal dopant is a mixture of palladium and titanium.

7. The binary or ternary metallic fuel composition of claim 2, wherein the metallic fuel is a ternary U—Pu—Zr alloy.

8. The binary or ternary metallic fuel composition of claim 7, wherein the metal dopant is a mixture of titanium and silver.

9. The binary or ternary metallic fuel composition of claim 7, wherein the metal dopant is a mixture of titanium and palladium.

10. The binary or ternary metallic fuel composition of claim 7, wherein the metal dopant is palladium.

11. The binary or ternary metallic fuel composition of claim 1, wherein a metal dopant to lanthanide atomic ratio is at least about 1:1.

12. The binary or ternary metallic fuel composition of claim 1, wherein a metal dopant to lanthanide atomic ratio is less than about 1:1.

13. The binary or ternary metallic fuel composition of claim 1, wherein the metal dopant is present in an amount in a range of from about 1 at. % to about 25 at. %.

14. The binary or ternary metallic fuel composition of claim 13, wherein the metal dopant is present in an amount in a range of from about 3 at. % to about 15 at. %.

15. A process to extend fuel burnup, comprising adding a metal dopant selected from the group consisting of titanium, palladium, silver, and mixtures thereof to a metallic fuel to achieve up to at least about a 14% burnup.

16. The process of claim 15, wherein the metallic fuel is an alloy of uranium, zirconium, plutonium, or combinations thereof.

17. The process of claim 16, wherein the metallic fuel is a binary U—Zr alloy.

18. The process of claim 17, wherein the metal dopant is titanium or palladium.

19. The process of claim 16, wherein the metallic fuel is a ternary U—Pu—Zr alloy.

20. The process of claim 19, wherein the metal dopant is a mixture of titanium and silver.

21. The process of claim 19, wherein the metal dopant is palladium.

22. The process of claim 15, wherein a metal dopant to lanthanide atomic ratio is greater than about 1:1.

23. The process of claim 15, wherein a metal dopant to lanthanide atomic ratio is less than about 1:1.

24. The process of claim 15, wherein the metal dopant is present in an amount in a range of from about 1 at. % to about 25 at. %.

25. The process of claim 24, wherein the metal dopant is present in an amount in a range of from about 3 at. % to about 15 at. %.

26. The process of claim 15, wherein up to at least about a 20% burnup is achieved.

27. The process of claim 26, wherein up to at least about a 30% burnup is achieved.

28. The process of claim 27, wherein up to at least about a 50% burnup is achieved.
